(19) United States
(12) Patent Application Publication
(10) Pub. No.: US 2014/0021712 A1
(43) Pub. Date: Jan. 23, 2014

(54) Recording Device for Scrapbooks

(71) Applicant: Leslie Knight, Fairview, TX (US)

(72) Inventor: Leslie Knight, Fairview, TX (US)

(21) Appl. No.: 13/550,983

(22) Filed: Jul. 17, 2012

(51) Int. Cl. B42D 1/08

(52) U.S. Cl. CPC B42D 1/08
USPC 281/15.1

(57) ABSTRACT

A scrapbook system to record audio corresponding to pictures on a scrapbook may include a base sheet, a recording device mounted on the base sheet, and a cover sheet to cover the recording device including the pictures of the scrapbook. The recording device may include a circuit board, a front panel to cover the circuit board and a rear panel being detachably connected to the front panel enabling access to the circuit board.

### FIELD OF THE INVENTION

The present invention relates to scrapbooks and more particularly to a recording device which may be used in conjunction with a scrapbook.

### BACKGROUND

It is known to associate audio messages with photographs in an album. For example, U.S. Pat. No. 5,574,519 to Manico et al. teaches a system of a photograph album and an audio storage device attached thereto. Bar coded labels are associated with individual photographs in the album. Scanning a bar coded label with a scanning wand sends an infrared signal to the storage device to control playback of an audio file in the storage device associated with the label. In order to record an audio message for association with a photograph, the storage device must be put into a ‘record’ mode and the label associated with the photograph is scanned to access a designated message address in the storage device and the message is then input into the storage device via a microphone. As a result, the bar coded labels, scanning wand and playback device must be present to record a message. Thus, such a system is not highly portable, not well-adapted for intimate recordings, such as the spontaneous and cherished verbal interactions between a grandparent and a grandchild, and in practice essentially requires that the photograph album (with bar coded labels applied) be assembled with photographs before recordings associated with the photographs can be recorded.

U.S. Pat. No. 7,063,266 discloses an accessory for a photograph album or scrapbook having a plurality of pages bound at a binding between front and back covers including at least one device sleeve and a digital storage and playback device at least partially contained within a device sleeve. The accessory also includes a system for coupling each device sleeve to a page, the front cover, or the back cover of the album. The playback device has a memory capable of storing a plurality of digital audio files and at least one button adapted to initiate playback of a selected one of said files.

U.S. Pat. No. 6,892,951 discloses a wallet accessory including a plurality of photograph sleeves, a digital playback device, and a device sleeve for the playback device. The device sleeve includes an opening within a face of the sleeve for purpose of permitting sound to enter a microphone of the playback device and permitting sound from a speaker of the playback device to be transmitted out of the device sleeve. The device includes a plurality of playback buttons and a plurality of the photograph sleeves includes respective indicia which associates one of the sleeves with a respective one of the buttons. As such, a photograph of a person in one of the photograph sleeves can be associated with a recorded message by that person which is played back by pressing a corresponding first button on the playback device.

U.S. Pat. No. 6,516,181 discloses an apparatus including in combination a storybook and a separate audio recording and playback device which may be joined for using prerecorded or spontaneously recorded information corresponding to the storyline of the storybook. The audio device may be used with several storybooks by recording the storyline of each book separately. Buttons corresponding to the several pages of the storybook are provided so that a young reader is able to correlate a button with each page to hear the story as well as read it.

Other patents and patent applications include U.S. Pat. No. 6,396,472, U.S. Pat. No. 6,381,573. U.S. Pat. No. 6,377,926, U.S. Pat. No. 6,148,173, US patent application 20070124673 and US patent application 20070030605.

The above patents and patent applications are incorporated by reference in their entirety

### SUMMARY

A scrapbook system to record audio corresponding to pictures on a scrapbook may include a base sheet, a recording device mounted on the base sheet, and a cover sheet to cover the recording device including the pictures of the scrapbook.

The recording device may include a circuit board, a front panel to cover the circuit board and a rear panel being detachably connected to the front panel.

The circuit board may include a non-volatile memory to retain the audio without power.

The memory may include random-access memory to retain the audio.

The circuit board may include a replaceable battery to power the circuit board.

The circuit board may include a speaker to playback audio signals.

The circuit board may include an on/off switch to turn on and turn off the circuit board.

The circuit board may include a record switch to activate recording.

The record switch may include a weakened area to detach the record switch.

The circuit board may include an activation switch to activate the circuit board.

The front panel may include adhesive.

The back panel may include adhesive.

The recording device may include a playback control switch to play the recorded message.

The recording device may include a microphone.

The playback control switch may be recessed to prevent unwanted playback of audio.

The front panel of the recording device may be detachable to replace a battery.

The playback control switch may extend beyond the top and bottom panels.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of a cover sheet, a recording device and a base sheet of the present invention

FIG. 2 illustrates a top view of the rear panel of the recording device of the present invention;

FIG. 3 illustrates a bottom view of the rear panel of the recording device of the present invention;

FIG. 4 illustrates a top view of the front panel of the recording device of the present invention;

FIG. 5 illustrates a bottom view of the front panel of the recording device of the present invention;

FIG. 6 illustrates a top view of the circuit board of the recording device of the present invention;

FIG. 7 illustrates a bottom view of the circuit board of the recording device of the present invention;

FIG. 8 illustrates a side view of the recording device of the present invention;

FIG. 9 illustrates a top view of the scrapbook system of the present invention;

FIG. 10 illustrates a bottom view of the scrapbook system of the present invention;

FIG. 11 illustrates an exploded view of the rear panel of the recording device of the present invention.

FIG. 12 illustrates an exploded view of the front panel of the recording device of the present invention.

### DETAILED DESCRIPTION

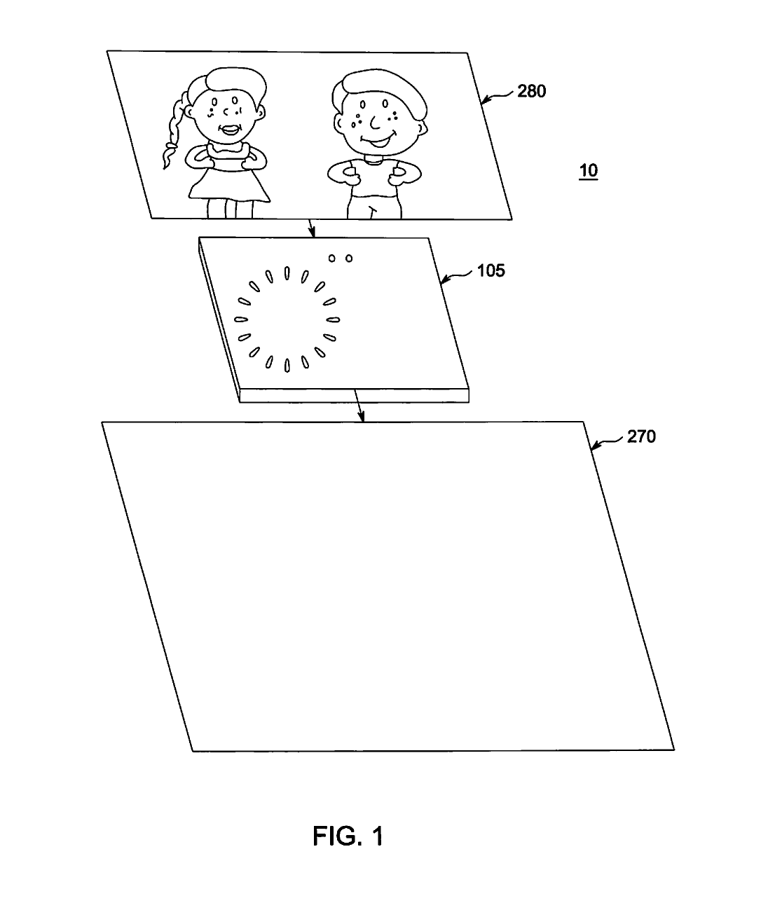

FIG. 1 illustrates an exploded view of a scrapbook system 10 of the present invention which may include a cover sheet 280 which may include indicia or pictures of family or friends which may be desirable to be placed into the scrapbook, a recording device 105 which may include the ability to record audio and to playback the recorded audio at a later time and may include a base sheet 270 which may be a page of a scrapbook. The base sheet 270 may be a flexible sheet of paper or light cardboard in order to provide a base for pictures and other memorabilia. The base sheet 270 may accept adhesive in order to fasten the recording device 105 on the base sheet 270. Likewise, the cover sheet 280 may accept adhesive in order to fasten the cover sheet 280 to the recording device 105. The above adhesive may be permanent or may be removable (non destructive) in order to temporarily or permanently remove the cover sheet 280 and the base sheet 270.

The recording device 105 of the present invention may include a circuit board 100 which may include the electronics to enable the recording device 105 to record sound, may include a front panel 110 to cooperate with the circuit board 100 and to cooperate with the cover sheet 280 and may include a rear panel 170 to cooperate with the circuit board 100 and to cooperate with the base sheet 270.

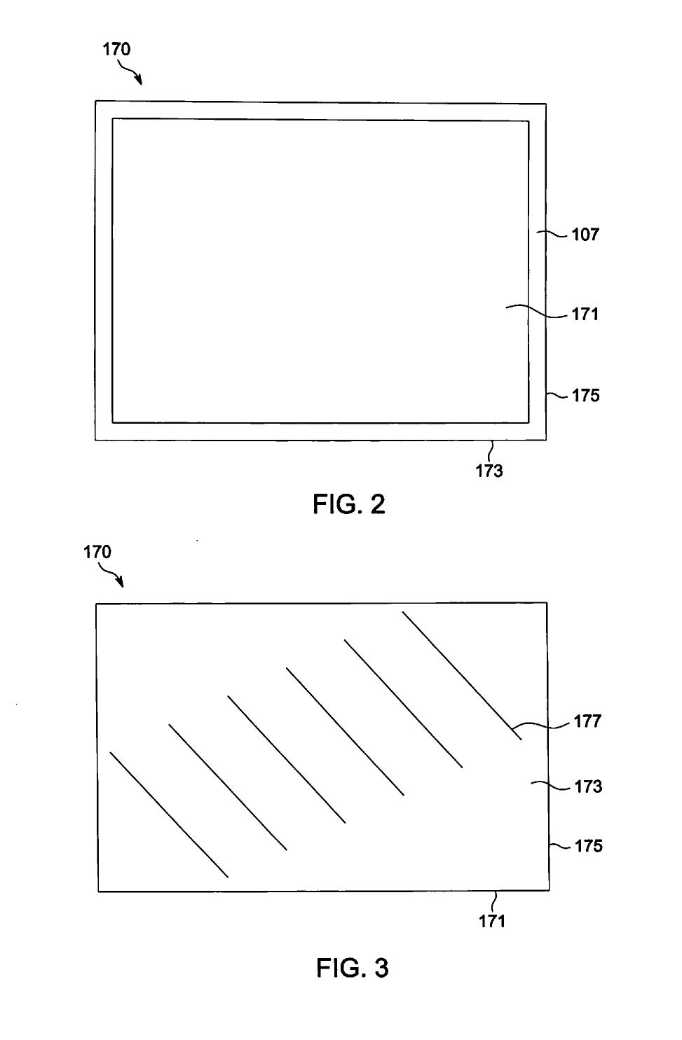

FIG. 2 illustrates a top view of the rear panel 170 which may include a substantially planar rear panel top surface 171 which may be opposed to a substantially planar rear panel bottom surface 173 and which may be connected to the rear panel bottom surface 173 by the substantially planar rear panel side surface 175. The rear panel bottom surface 173 an adhesive with a removable (non destructive) protective sheet 177 (not shown in FIG. 2) may be connected to the base sheet 270 and the rear panel top surface 171 may be detachably connected to the bottom circuit board surface 103 of the circuit board 100. The rear panel top surface 171 may include a peripheral wall 107 which may extend around the periphery of the circuit board 100. The rear panel 170 may be flexible or rigid and may be formed from foam board, cardboard, or paper which may be acid-free, flexible and compressible.

FIG. 3 illustrates a bottom view of the rear panel 170 which may include a substantially planar rear panel top surface 171 which may be opposed to a substantially planar rear panel bottom surface 173 and which may be connected to the rear panel bottom surface 173 by the substantially planar rear panel side surface 175. The rear panel bottom surface 173 an adhesive with a removable (non destructive) protective sheet 177 may be connected to the base sheet 270. The rear panel top surface 171 may be detachably connected to the bottom circuit board surface 101 from the circuit board 100. The rear panel 170 may be flexible or rigid and maybe formed from foam board, cardboard, or paper which may be acid-free, flexible and compressible.

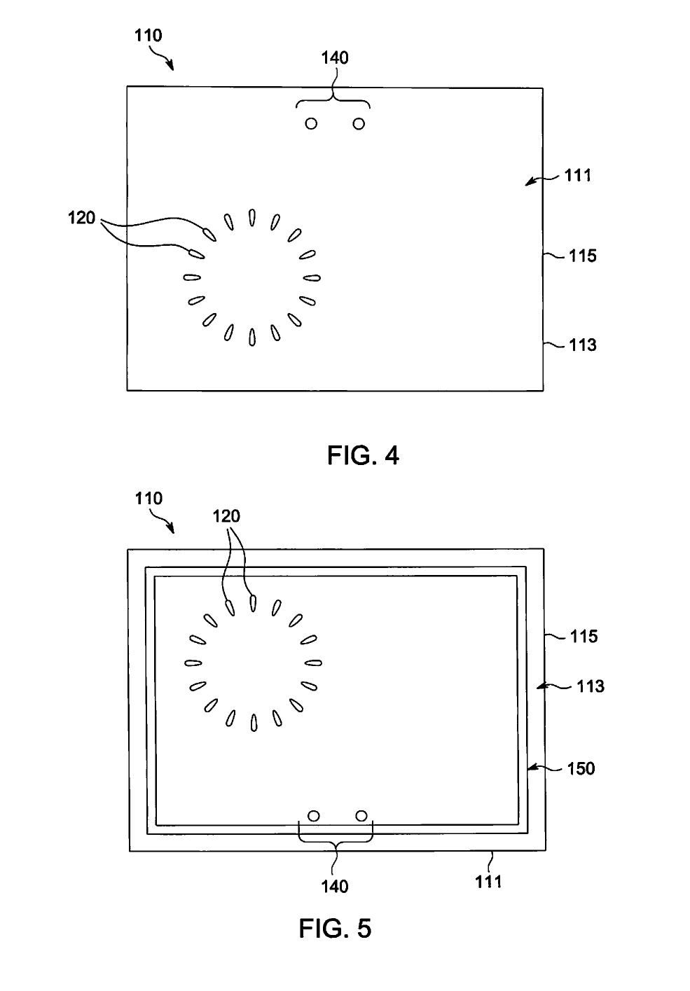

FIG. 4 illustrates a top view of the front panel 110 which may include a substantially planar front panel top surface 111 which may be opposed to a substantially planar front panel bottom surface 113 and which may be connected to the front panel bottom surface 113 by the substantially planar front panel side surface 115. The front panel top surface 111 an adhesive with a removable (non destructive) protective sheet 117 (not shown in FIG. 4) may be connected to the cover sheet 280. FIG. 4 additionally illustrates a multitude of first apertures 120 which may extend through the front panel 110 to cooperate with a recorder speaker 210 (not shown in FIG. 4) which may broadcast the recorded sounds on the recording device 105 by allowing the recorded sounds to escape from the recording device 105. FIG. 4 additionally illustrates a multitude of second apertures 140 which may extend through the front panel 110 to allow the sound to be recorded to reach the microphone 220 (not shown in FIG. 4). The front panel 110 may be flexible or rigid and maybe formed from foam board, cardboard or paper which may be acid-free, flexible and compressible.

FIG. 5 illustrates a bottom view of the front panel 110 which may include a substantially planar front panel top surface 111 which may be opposed to a substantially planar front panel bottom surface 113 and which may be connected to the front panel bottom surface 113 by the substantially planar front panel side surface 115. The front panel bottom surface 113 may include an offset wall 150 which may extend around the front panel bottom surface 113 to cooperate with the peripheral wall 107 in order to form a substantial seal. FIG. 5 additionally illustrates a multitude of first apertures 120 which may extend through the front panel 110 to cooperate with a recorder speaker 210 (not shown in FIG. 5) which may broadcast the recorded sounds on the recording device 105 by allowing the recorded sounds to escape from the recording device 105. FIG. 5 additionally illustrates a multitude of second apertures 140 which may extend through the front panel 110 to allow the sound to be recorded to reach the microphone 220 (not shown in FIG. 5). The front panel 110 may be flexible or rigid and maybe formed from foam board, cardboard or paper which may be acid-free, flexible and compressible.

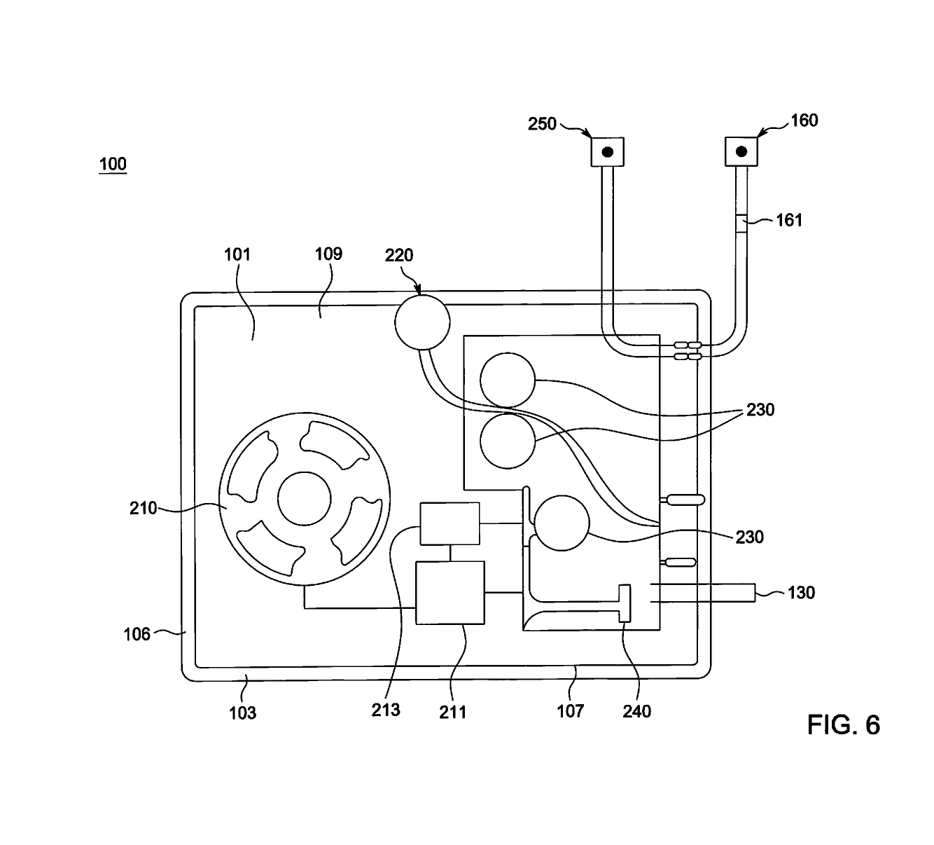

FIG. 6 illustrates the circuit board 100 which may include a microprocessor 211 to control the recording device 105, a speaker 210 to broadcast the recorded audio, a memory 213 to store the recorded audio such as digital memory including non-volatile random access memory RAM to maintain the recorded audio despite power failure, batteries 230 which may be replaceable in order to maintain a power supply for the circuit board 100, a playback control switch 250 to activate the recorded audio and to playback through the recorder speaker 210, a record control switch 160 to activate and deactivate the recording and storage in the memory 213, the audio being concurrently received by the microphone 220, an on/off switch 240 to turn on and turn off the recording device 105 and an activation switch 130 to provide a one-time activation of the recording device 105 in order to extend the shelf life of the batteries 230.

The microprocessor 211 may be electrically connected to the memory 213, the playback control switch 250, the record control switch 160, the batteries 230, the speaker 210, the microphone 220, the on/off switch 240 and the activation switch 130.

In operation, the activation switch 130 may be activated to initially turn on the recording device 105, the user may turn off or turn on the recording device 105 by activating the activation switch 130. When the user has turned on the recording device 105, the user may activate the playback control switch 250 to activate the memory 213 to send the audio signals to the recorder speaker 210 so that the user can hear the audio signals. The playback control switch may extend outside the boundaries of the peripheral wall 107 and may be hidden by a coversheet, indicia or embellishment, which may be desirable to be placed into the scrapbook. Alternatively, the user may activate a record control switch 160 to activate the recording of audio signals. The microphone 220 may be activated to receive the audio from the user, and the microphone 220 may transmit the audio signals to the memory 213 where the audio signals are stored for future playback.

The record control switch 160 may provide an audio or visual alarm while the record control switch 160 has been activated for recording audio through the microphone 220. When the user has finished recording, the user may press the record control switch 160 a second time to stop the recording of audio from the user. Another audio or visual alarm may indicate that the recording has ended by the user or may indicate that the recording device 105 has reached the end of the memory 213 and cannot continue recording. The wires connecting the record control switch 160 may include a weakened area 161 so that the record control switch 160 may be separated in order to create a permanent recording which may not be recorded over.

The circuit board 100 may include a circuit board top surface 101 which may be opposed to a circuit board bottom surface 103 and which may be connected to a circuit board side surface 106 by the circuit board bottom surface 103. A peripheral wall 107 extends around the periphery of the circuit board 100 in order to define a cavity 109 for the above-mentioned electrical elements.

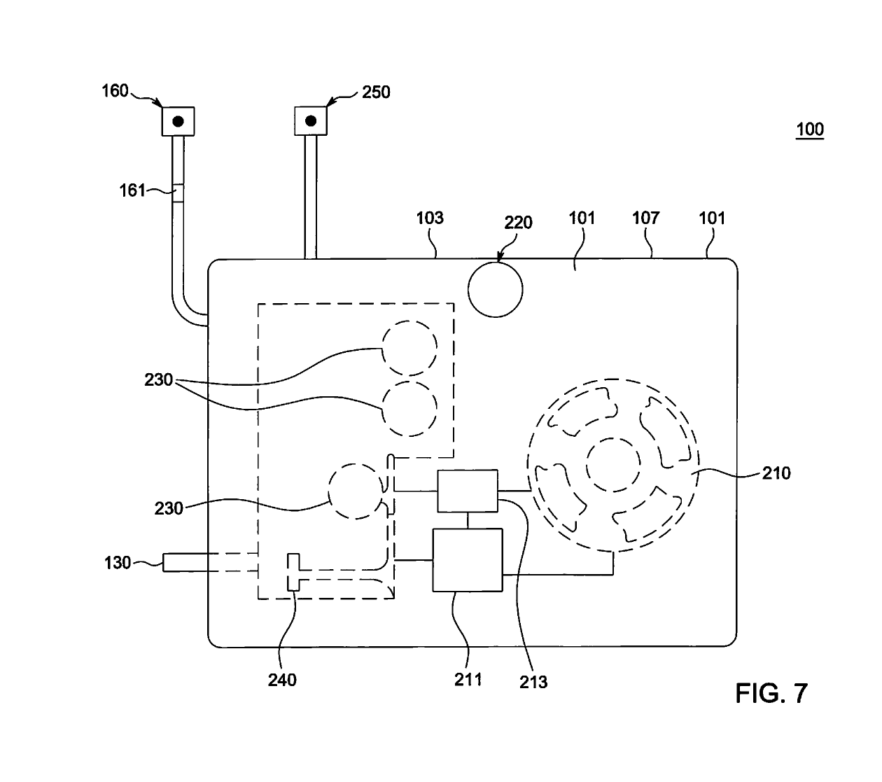

FIG. 7 illustrates a bottom view of the circuit board 100 which may include a microprocessor 211 to control the recording device 105, a speaker 210 to broadcast the recorded audio, a memory 213 to store the recorded audio such as digital memory including non-volatile random access memory RAM to maintain the recorded audio despite power failure, batteries 230 which may be replaceable in order to maintain a power supply for the circuit board 100, a playback control switch 250 to activate the recorded audio and to playback through the recorder speaker 210, a record control switch 160 to activate and deactivate the recording and storage in the memory 213 the audio being concurrently received by the microphone 220 an on/off switch 240 to turn on and turn off the recording device 105 and an activation switch 130 to provide a one-time activation of the recording device 105 in order to extend the shelf life of the batteries 230.

The microprocessor 211 may be electrically connected to the memory 213, the playback control switch 250, the record control switch 160, the batteries 230, the speaker 210, the microphone 220, the on/off switch 240 and the activation switch 130.

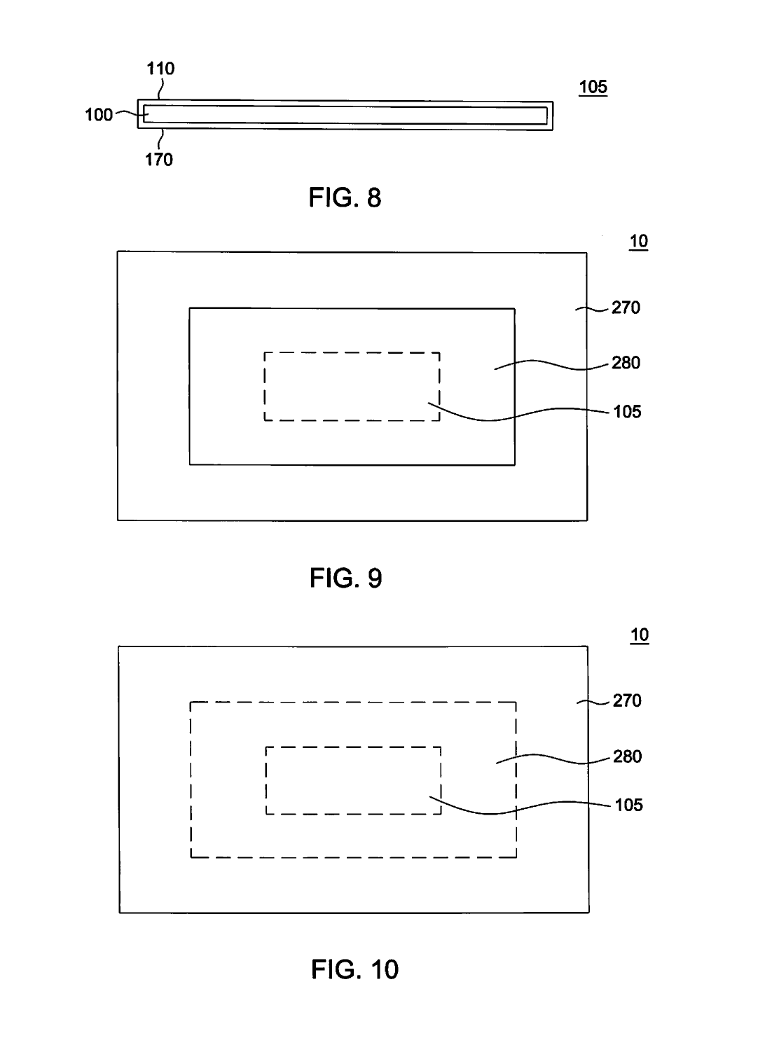

FIG. 8 illustrates a side view of the recording device 105, front panel 110, the rear panel 170 and the circuit board 100 which may be sandwiched between the front panel 110 and the rear panel 170. FIG. 8 additionally illustrates the peripheral wall 107.

FIG. 9 illustrates a top view of a scrapbook system 10 of the present invention which may include a cover sheet 280 which may include indicia or pictures of family or friends which may be desirable to be placed into the scrapbook, a recording device 105 which may include the ability to record audio and to playback the recorded audio at a later time and may include a base sheet 270 which may be a page of a scrapbook. The base sheet 270 may be a flexible sheet of paper or light cardboard in order to provide a base for pictures and other memorabilia. The base sheet 270 may accept adhesive (non destructive) in order to fasten the recording device 105 on the base sheet 270. Likewise, the cover sheet 280 may accept adhesive (non destructive) in order to fasten the cover sheet 280 to the recording device 105. The above adhesive may be permanent or may be removable (non destructive) in order to temporarily or permanently remove the cover sheet 280 and the base sheet 270.

FIG. 10 illustrates a bottom view of a scrapbook system 10 of the present invention which may include a cover sheet 280 which may include indicia or pictures of family or friends which may be desirable to be placed into the scrapbook, a recording device 105 which may include the ability to record audio and to playback the recorded audio at a later time and may include a base sheet 270 which may be a page of a scrapbook. The base sheet 270 may be a flexible sheet of paper or light cardboard in order to provide a base for pictures and other memorabilia. The base sheet 270 may accept adhesive in order to fasten the recording device 105 on the base sheet 270. Likewise, the cover sheet 280 may accept adhesive in order to fasten the cover sheet 280 to the recording device 105. The above adhesive may be permanent or may be removable (non destructive) in order to temporarily or permanently remove the cover sheet 280 and the base sheet 270.

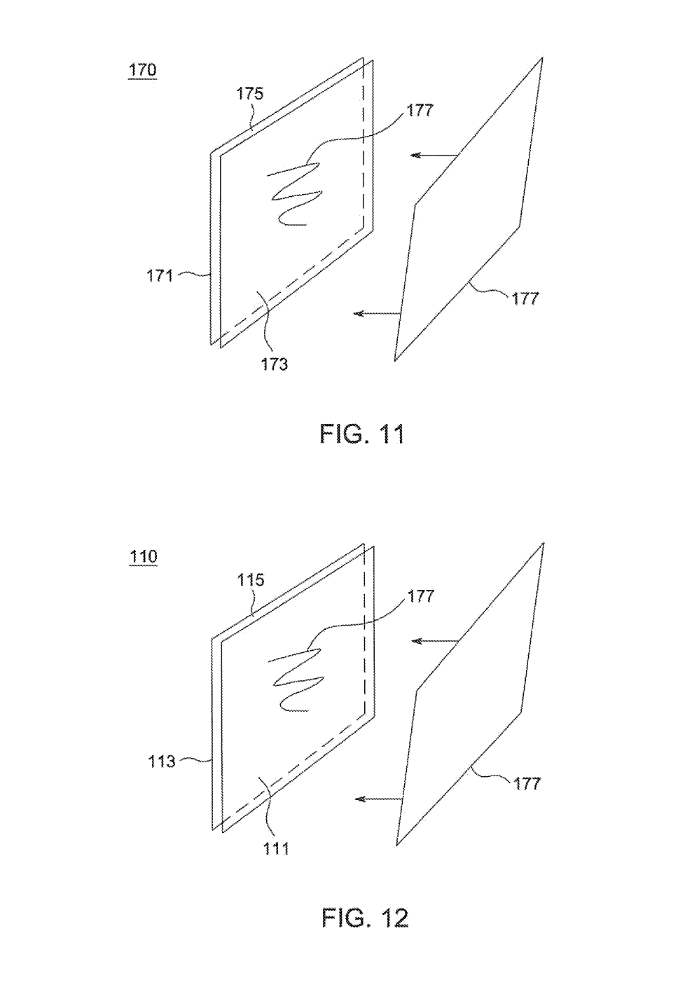

FIG. 11 illustrates an exploded view of the rear panel 170 which may include a substantially planar rear panel top surface 171 which may be opposed to a substantially planar rear panel bottom surface 173 and which may be connected to the rear panel bottom surface 173 by the substantially planar rear panel side surface 175. The rear panel bottom surface 173 an adhesive with a removable protective sheet 177 may be connected to the base sheet 270 and the rear panel top surface 171 to be detachably connected to the bottom circuit board surface 103 of the circuit board 100 (not shown in FIG. 11).

FIG. 12 illustrates an exploded view of the front panel 110 which may include a substantially planar front panel top surface 111 which may be opposed to a substantially planar front panel bottom surface 113 and which may be connected to the front panel bottom surface 113 by the substantially planar front panel side surface 115. The front panel top surface 113 an adhesive with a removable protective sheet 117 may be connected to the cover sheet 280 and the front panel bottom surface 113 may include an offset wall 150 which extends around the front panel bottom surface 113 to cooperate with the peripheral wall 107 in order to form a substantial seal.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A scrapbook system to record audio corresponding to pictures on a scrapbook, comprising:
a base sheet;
a recording device mounted on the base sheet;
a cover sheet to cover the recording device including the pictures of the scrapbook;
wherein the recording device includes a circuit board, a front panel to cover the circuit board and a rear panel being detachably connected to the front panel.

2) A scrapbook system to record audio corresponding to pictures on a scrapbook as in claim 1, where in the circuit board includes a non-volatile memory to retain the audio without power.

3) A scrapbook system to record audio corresponding to pictures on a scrapbook as in claim 2, wherein the memory includes random-access memory to retain the audio.

4) A scrapbook system to record audio corresponding to pictures on a scrapbook as in claim 1, wherein the circuit board includes a replaceable battery to power the circuit board.

5) A scrapbook system to record audio corresponding to pictures on a scrapbook as in claim 1, wherein the circuit board includes a speaker to playback audio signals.

6) A scrapbook system to record audio corresponding to pictures on a scrapbook as in claim 1, wherein the circuit board includes an on/off switch to turn on and turn off the circuit board.

7) A scrapbook system to record audio corresponding to pictures on a scrapbook as in claim 1, wherein the circuit board includes a record switch to activate recording.

8) A scrapbook system to record audio corresponding to pictures on a scrapbook as in claim 7, wherein the record switch includes a weakened area to detach the record switch.

9) A scrapbook system to record audio corresponding to pictures on a scrapbook as in claim 1, wherein the circuit board includes an activation switch to activate the circuit board.

10) A scrapbook system to record audio corresponding to pictures on a scrapbook as in claim 1, wherein the front panel includes adhesive.

11) A scrapbook system to record audio corresponding to pictures on a scrapbook as in claim 1, wherein the back panel includes adhesive.

12) A scrapbook system to record audio corresponding to pictures on a scrapbook as in claim 1, wherein the recording device includes a playback control switch to play the recorded message.

13) A scrapbook system to record audio corresponding to pictures on a scrapbook as in claim 1, wherein the recording device includes a microphone.

14) A scrapbook system to record audio corresponding to pictures on a scrapbook as in claim 12, wherein the playback control switch is recessed to prevent unwanted playback of audio.

15) A scrapbook system to record audio corresponding to pictures on a scrapbook as in claim 1, wherein the front panel is detached to replace a battery.

16) A scrapbook system to record audio corresponding to pictures on a scrapbook as in claim 13, wherein the playback control switch extends beyond the top and bottom panels.
